(19) United States
(12) Patent Application Publication
(10) Pub. No.: US 2026/0001557 A1
(43) Pub. Date: Jan. 1, 2026

(54) CONTROL, CONTROL METHOD, IN-CABIN MONITORING SYSTEM, VEHICLE

(71) Applicant: Sony Semiconductor Solutions Corporation, Atsugi-shi, Kanagawa (JP)

(72) Inventors: Vladimir ZLOKOLICA, Basingstoke (GB); Varun ARORA, Basingstoke (GB); Dmitry KOVALEV, Basingstoke (GB); Jan Martin JUPTNER, Basingstoke (GB)

(73) Assignee: Sony Semiconductor Solutions Corporation, Atsugi-shi, Kanagawa (JP)

(21) Appl. No.: 18/879,293

(22) PCT Filed: Jul. 5, 2023
(86) PCT No.: PCT/EP2023/068590

§ 371 Date: Dec. 27, 2024

(30) Foreign Application Priority Data
Jul. 6, 2022 (EP) 22183353.6

(51) Int. Cl. B60W 40/09; B60R 21/015; B60W 40/08; G01S 13/04; G01S 13/86

(52) U.S. Cl. CPC B60W 40/09; B60R 21/01534; G01S 13/04; G01S 13/865; B60W 2040/0881; B60W 2420/408; B60W 2422/00

(57) ABSTRACT

A control for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, comprising circuitry configured to: obtain time-of-flight data and radar data; perform, based on the time-of-flight data and the radar data, object/passenger monitoring in the cabin; detect, based on the time-of-flight data, a region of interest in the cabin; and adapt, based on the detected region of interest, an operation mode of the in-cabin monitoring system.

### TECHNICAL FIELD

The present disclosure generally pertains to a control and a control method for an in-cabin monitoring system for a vehicle, an in-cabin monitoring system and a vehicle.

### TECHNICAL BACKGROUND

Currently, the in-cabin monitoring systems for monitoring objects/passengers in a cabin of a vehicle are usually based on direct sensing, using RGB (“red-green-blue”), IR (“infrared”), iToF (“indirect time-of-flight”) and radar sensing systems.

When, for example, the vehicle is a car, some systems employ driver monitoring and occupant detection and recognition. Typically, only one single sensor has been used for driver monitoring and another completely independent sensing system has been used for occupant detection, wherein, e.g., “child left alone in the car” represents a use case.

Radar technology is, for instance, used in-cabin monitoring systems for monitoring, e.g., child presence (with full cover or not) and for counting number of occupants, however, its performance on these basic functionalities, as a stand-alone radar-based system, may be dependent on a priory knowledge of the seating positions and footwell in the vehicle. In some cases, as generally known, radar solutions may have certain detection characteristics and may require complex algorithms to process all in-cabin data to provide the whole required functionality. For example, a specific distance between occupants may be assumed, whereas there might be cases where the two occupants are closer to each other and, thus, merge into one blob detection.

Although there exist techniques for in-cabin monitoring systems, it is generally desirable to improve the existing techniques.

### SUMMARY

According to a first aspect the disclosure provides a control for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, comprising circuitry configured to:
obtain time-of-flight data and radar data;
perform, based on the time-of-flight data and the radar data, object/passenger monitoring in the cabin;
detect, based on the time-of-flight data, a region of interest in the cabin; and
adapt, based on the detected region of interest, an operation mode of the in-cabin monitoring system.

According to a second aspect the disclosure provides a control method for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, comprising:
obtaining time-of-flight data and radar data;
performing, based on the time-of-flight data and the radar data, object/passenger monitoring in the cabin;
detecting, based on the time-of-flight data, a region of interest in the cabin; and
adapting, based on the detected region of interest, an operation mode of the in-cabin monitoring system.

According to a third aspect the disclosure provides an in-cabin monitoring system for a vehicle, comprising:
a time-of-flight device configured to perform a time-of-flight measurement to acquire time-of-flight data;
a radar device configured to perform a radar measurement to acquire radar data; and
a control, including circuitry configured to:
   obtain time-of-flight data and radar data,
   perform, based on the time-of-flight data and the radar data, object/passenger monitoring in the cabin,
   detect, based on the time-of-flight data, a region of interest in the cabin, and
   adapt, based on the detected region of interest, an operation mode of the in-cabin monitoring system.

According to a fourth aspect the disclosure provides a vehicle, comprising an in-cabin monitoring system including:
a time-of-flight device configured to perform a time-of-flight measurement to acquire time-of-flight data;
a radar device configured to perform a radar measurement to acquire radar data; and
a control, including circuitry configured to:
   obtain time-of-flight data and radar data,
   perform, based on the time-of-flight data and the radar data, object/passenger monitoring in the cabin,
   detect, based on the time-of-flight data, a region of interest in the cabin, and adapt, based on the detected region of interest, an operation mode of the in-cabin monitoring system.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a side view an embodiment of a vehicle including an in-cabin monitoring system;

FIG. 2 schematically illustrates in a bird's-eye view an embodiment of a vehicle including an in-cabin monitoring system;

FIG. 3 schematically illustrates in a block diagram an embodiment of an in-cabin monitoring system; and

FIG. 4 schematically illustrates in a flow diagram an embodiment of a control method for an in-cabin monitoring system for a vehicle.

### DETAILED DESCRIPTION OF EMBODIMENTS

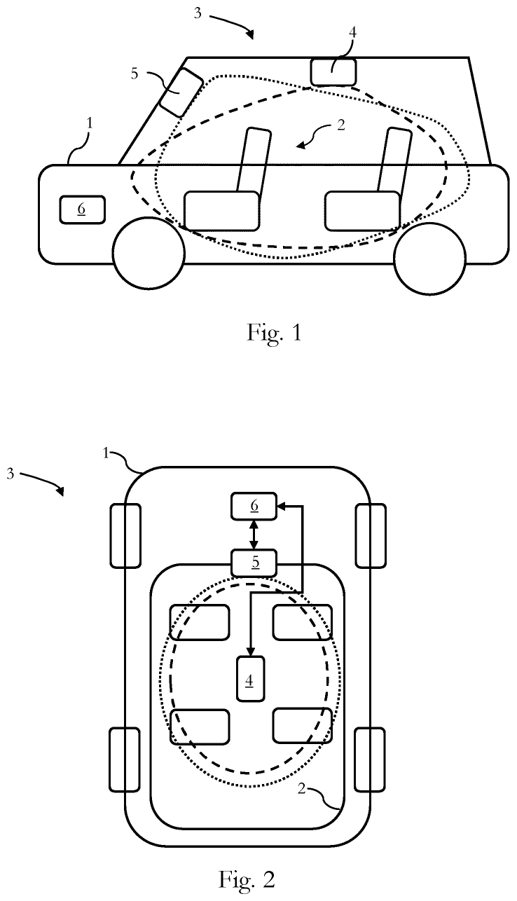

Before a detailed description of the embodiments under reference of FIG. 1 is given, general explanations are made.

As mentioned in the outset, currently, the in-cabin monitoring systems for monitoring objects/passengers in a cabin of a vehicle are usually based on direct sensing, using RGB (“red-green-blue”), IR (“infrared”), iToF (“indirect time-of-flight”) and radar sensing systems.

As further mentioned in the outset, when, for example, the vehicle is a car, some systems employ driver monitoring and occupant detection and recognition. Typically, only one single sensor is used for driver monitoring and another completely independent sensing system is used for occupant detection, wherein, e.g., “child left alone in the car” represents a use case.

The driver monitoring is presently predominantly related to driver face monitoring, usually done using high spatial resolution 2D IR cameras to extract the facial features and activity. A typical position of the camera monitoring system is the dashboard, assuming the face is clearly seen without occlusions. Besides the facial features, for example, the driver monitoring system monitors the driver head orientation.

Another setup possibilities include rear-mirror positioned cameras with a wider field of view (FoV), which potentially reduce the spatial resolution of the facial features but may provide extended information about the full cabin.

It has been recognized that, for example, a dashboard high resolution camera may be used in combination with the larger FoV camera placed in the rear-mirror view position (or some other application driven position), which may increase the performance of the system by sensor fusion.

In recent years, occupant and child detection systems have moved from indirect sensing (e.g., sensing of open (back) doors) to direct sensing where, for instance, radar sensors play a role because of their ability to detect tiny movements bellow a cover, i.e., with visual occlusion. Such radar sensors are used, for instance, also in-cabin monitoring systems for monitoring, e.g., child presence (with full cover or not) and for counting the number of occupants, however, its performance on these basic functionalities, as a stand-alone radar-based system, may be dependent on an a priory knowledge of the seating positions and the footwell in the vehicle. In some cases, as generally known, radar solutions may have certain detection characteristics and may require complex algorithms to process all in-cabin data to provide the whole required functionality. For example, a specific distance between occupants may be assumed, whereas there might be cases where the two occupants are closer to each other and, thus, may merge into one blob detection (hence missing some occupants because of limited resolution and signal to noise ratio (SNR)).

One additional example may be a child seating in an adult's lap or animals in the lap. Additionally, if the occupants are not moving and, for example, sleeping the occupant presence may be missed because of not clear classification between the empty seat and the occupant not moving at all. Further, in some cases, radar-based solutions may not be optimized to detect the occupants' pose/shape and type of activity, which may become more important for future safety applications—for example: the car is driven and in the back the children are doing something that might not be safe.

It has been recognized that although, currently, the position of the seats is mostly fixed, the front seats can move, and the rear seats can be assembled down and/or shifted such that the footwell area can change as well. Moreover, it has been recognized that soon, as the level of autonomy increases, such as level 3 and above, it is expected that the seat positions will be more movable and the footwell will also change and, thus, it becomes more important to detect and recognize the areas of interest for monitoring.

It has further been recognized that radar sensing devices, however, may be useful for detection, for example, for detecting tiny respiration or movements of a child under the blanket.

It has been recognized that, in some cases, however, the reflection of the radar signal caused by tiny and slow motions may have a limited level of SNR that may necessitate application of specific processing technics to extract information, for example, about the tiny respiration or movements of the child. Such a relatively low SNR, in addition with possible presence of clutter (e.g., vibration of the vehicle) may lower the performance of the system.

Even though, there are some typical so-called Doppler signatures for specific gestures that can be used to recognize gestures (finger rotate, palm push, etc.), the information extracted from the radar signal alone may not be sufficient to provide the needed level of certainty about the performed gesture in some cases.

Hence, it has been recognized that, in some embodiments, to reach a higher level of performance and reduce computational resources needed to process the radar signal, the 3D location and size of the object of interest (e.g., human body or child seat covered with a blanket) should be known. It has been recognized that extra information from a time-of-flight sensor should be used in addition to improve the performance compared to the radar only system.

Thus, in some embodiments, sensor fusion of radar signals with iToF (“indirect time-of-flight”) 3D sensing technology is employed.

It has been recognized that an improvement may be reached by: (1) dynamically adapting the 3D region of interest, where, for example, the recognition of the hand gesture should take place, and (2) by providing extra information about the 3D structure of the hand and its location in the region of interest that, for instance, may help to discriminate the gestures such as clockwise/counterclockwise finger rotation or finger tap in and tap out, etc.

Moreover, it has been recognized that, in some embodiments, the radar sensing device functionality should be optimized to optimize its device parameters given specific information about the object of interest and, thus, further improve the processing of the data for recognition and decision making. In some embodiments, the radar internal tuning parameters include: 1) field of view and/or 2) angular/distance resolution, and/or 3) power mode and/or 4) a frame rate.

Furthermore, in some embodiments, in addition to sensor fusion of the ToF and radar data (e.g., using processed output of one device to adapt the processing of other device data), an adaptive tuning of the sensing device parameters in real-time is employed.

In some embodiments, the in-cabin monitoring system covers, based on radar and time-of-flight data fusion, full in-cabin monitoring including child presence monitoring, passenger pose/activity/interaction monitoring, identification and activity monitoring of occluded and non-occluded objects/passengers in the vehicle for safety/crash protection purposes and comfort. Hence, some embodiments pertain to a control for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, wherein the control includes circuitry configured to:
obtain time-of-flight data and radar data;
perform, based on the time-of-flight data and the radar data, object/passenger monitoring in the cabin;
detect, based on the time-of-flight data, a region of interest in the cabin; and
adapt, based on the detected region of interest, an operation mode of the in-cabin monitoring system.

Some embodiments pertain to an in-cabin monitoring system for a vehicle, wherein the in-cabin monitoring system includes a time-of-flight device configured to perform a time-of-flight measurement to acquire time-of-flight data, a radar device configured to perform a radar measurement to acquire radar data, and a control, wherein the control includes circuitry configured to:
obtain time-of-flight data and radar data,
perform, based on the time-of-flight data and the radar data, object/passenger monitoring in the cabin,
detect, based on the time-of-flight data, a region of interest in the cabin, and
adapt, based on the detected region of interest, an operation mode of the in-cabin monitoring system.

Some embodiments pertain to a vehicle, wherein the vehicle includes an in-cabin monitoring system, which includes a time-of-flight device configured to perform a time-of-flight measurement to acquire time-of-flight data, a radar device configured to perform a radar measurement to acquire radar data, and a control, wherein the control includes circuitry configured to:
obtain time-of-flight data and radar data,
perform, based on the time-of-flight data and the radar data, object/passenger monitoring in the cabin,
detect, based on the time-of-flight data, a region of interest in the cabin, and
adapt, based on the detected region of interest, an operation mode of the in-cabin monitoring system.

The vehicle may be a car, a train, an aircraft or the like, which has a cabin with space for objects/passengers.

The time-of-flight device may be a direct time-of-flight device (which may also be referred to as LiDAR (“Light Detection And Ranging”)) or an indirect time-of-flight device, which are generally known.

Thus, in some embodiments, the time-of-flight device is an indirect time-of-flight device. Typically, in some embodiments, an indirect time-of-flight device includes one or more image sensors, such as a pixel array of a plurality of CAPD (“current-assisted photonic demodulator”) pixels (which are two-tapped in some embodiments), one or more light sources such as a laser diode array (e.g., emitting visible or infrared light) and a control for controlling the overall operation.

As generally known, in some embodiments, the indirect time-of-flight device performs a time-of-flight measurement based on a plurality of correlation measurements (usually four correlation measurements) in which a modulation signal is applied phase-shifted (e.g., 0°, 90°, 180° and) 270° to the image sensor and the light source (the signal is phase-shifted between image sensor and light source).

In some embodiments, the time-of-flight data is acquired based on these correlation measurements by analog-to-digital conversion to obtain an amplitude image or a phase image, as generally known, wherein the amplitude image represents 2D image formation and the phase image represents 3D image information based on which a 3D point cloud may be generated.

Typically, in some embodiments, the radar device emits a high-frequency electromagnetic wave (for example, in the GHz (Gigahertz) regime such that wavelengths are in the mm (millimeter) range) and detects a portion of the electromagnetic wave that has been reflected by an object/passenger.

In some embodiments, the radar device measures (acquires), for example, a relative (radial) velocity of an object and a distance to the object, or a relative (radial) velocity of an object, a distance to the object and at least one detection angle (azimuth and/or elevation) to the object.

Moreover, in some embodiments, the radar device includes a plurality of transmission/reception antennas with which the angular/distance/velocity resolution and/or a field of view is adapted, for example, by applying phase-shifted modulation signals to the transmission/receiving antennas, as generally known.

In some embodiments, the radar device employs an antenna with a fixed pattern of transmit and receive elements and the shape of the elements (patches on the PCB connected to TX and RX channels of radar), the field of view, as the area in space (solid angle) to which the most of transmit signal will be emitted and from which the reflected signal will be received, is fixed. In some embodiments, for example, it is switched (the control instructs switching) between two independent antennas on the PCB to adjust the field of view. In some embodiments, it is switched between to different antenna array of the radar device to adapt the field of view of the radar device.

In some embodiments, the angular/distance/velocity resolution and a power mode are adapted by adjusting radar signal parameters and/or adjusting a number of activated RX/TX channels. The radar data may include at least one of the relative (radial) velocity of the object, the distance to the object and the detection angles to the object (the azimuth and the elevation), as generally known, and, thus, represents 3D information about the object.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus. The data bus may be or may be based on a Controller Area Network (CAN) bus, an I²C (Inter-Integrated Circuit) interface, or the like.

The control may obtain the time-of-flight data and the radar data over a data bus to which the time-of-flight device and the radar device are connected (e.g., a CAN bus).

The control may transform the radar data and the time-of-flight data into a single coordinate system to overlap/combine the different data sets (e.g., based on known installation positions/orientations within the cabin).

Generally, the control performs, based on the time-of-flight data and the radar data, object/passenger monitoring in the cabin.

In some embodiments, performing object/passenger monitoring includes detecting a presence of an object/passenger in the cabin, registration of the detected object/passenger, tracking of the detected object/passenger in the cabin and recognition of a behavior of the detected object/passenger.

In some embodiments, performing object/passenger monitoring includes detecting occlusions of objects/passengers. In some embodiments, the control complements information extracted based on the time-of-flight data and information extracted based on the radar data, for example, for detecting occlusions of objects/passengers.

The control detects, based on the time-of-flight data, a region of interest in the cabin.

The region of interest may be associated with an object (e.g., a child seat, some luggage, or the like) or a passenger (e.g., a driver, a child, an animal, or the like) such that, for example, 2D/3D coordinates indicating a (n) area/space around the (whole) object/passenger represents the region of interest.

In some embodiments, the region of interest is a three-dimensional region of interest. In some embodiments, the region of interest corresponds to a three-dimensional box.

In some embodiments, the control determines, based on the time-of-flight data, a three-dimensional localization, orientation and/or a size and/or shape of the region of interest. In some embodiments, the control determines the three-dimensional localization, orientation and/or a size and/or shape of the region of interest based on the depth information (e.g., phase image) and/or the reflection information (e.g., amplitude image).

In some embodiments, the region of interest represents a first rough estimate of important parts in the cabin for further monitoring. In some embodiments, the region of interest may be detected based on the amplitude image by a simple edge detection or the like without requiring to construct a 3D point cloud (over a plurality of time points) based on the phase image to save computational resources.

Generally, in some embodiments, bi-directional adaptations of both sensing pipelines for the in-cabin monitoring system is employed. For the sensor fusion, the time-of-flight processed data (acquired by the time-of-flight sensor) is used for rough 3D localization and recognition of the 3D regions of interest, related to volumes of occupants, child seat, children, animals and other objects of interest. Once a rough position is detected and initial estimate of the occupant position is known, in some embodiments, the radar sensing is used for more detailed occupant inspection and monitoring in terms of tiny/fine movements and breathing for example. This may be important for cases when occupants are not moving at all, for example sleeping, in which case it may be difficult for only radar-system to distinguish between the background (seat) and the occupant. Using the time-of-flight data may help to avoid occupant detection and localization miss, i.e., false negative. Apart from the point cloud data, in some embodiments, also (time-of-flight) confidence data may be used to detect, e.g., the head region of interest, in case it is not visually occluded.

In other words, it is envisaged to iteratively adapt, in some embodiments, the data processing and the data acquisition for optimizing the in-cabin monitoring system for a given situation, wherein the in-cabin monitoring system may be optimized, for example, with respect to detection accuracy of objects/passengers and their behavior or with respect to detection speed or with respect to power consumption or a combination thereof.

Hence, the control adapts, based on the detected region of interest, an operation mode of the in-cabin monitoring system.

In some embodiments, the operation modes are predetermined. For example, the in-cabin monitoring system may be operated in a reduced power mode, an object/passenger presence detection/registration mode for detecting/registering the region(s) of interest, an object/passenger tracking mode and an object/passenger behavior recognition mode.

In some embodiments, adapting an operation mode includes adapting a data processing mode of the control and/or adapting a data acquisition mode of the time-of-flight device and/or the radar device.

In some embodiments, adapting a data acquisition mode of the radar device includes adapting device parameters including at least one of a field of view, a frame rate, an angular/distance/velocity resolution and a power mode.

In some embodiments, adapting a data acquisition mode of the time-of-flight device includes adapting device parameters including at least one of an integration time, a frame rate, a modulation frequency, a field of illumination, multi-wavelength light emission and a power mode.

In some embodiments, the circuitry is configured to extract, based on the radar data, information regarding passenger presence and/or behavior of the passenger in the cabin using the detected region of interest as prior knowledge.

In some embodiments, the circuitry is configured to detect, based on the time-of-flight data, at least one sub-region of interest in the region of interest using the extracted information as prior knowledge.

In some embodiments, the circuitry is configured to extract, based on the time-of-flight data and the radar data, information regarding passenger presence and/or behavior of the passenger in the cabin in the sub-region of interest.

As mentioned above, it is envisaged to iteratively adapt the operation mode of the in-cabin monitoring system with respect to data processing and/or data acquisition.

For illustration:

The control may detect the region of interest based on the time-of-flight data in the object/passenger presence detection/registration mode in which the time-of-flight device parameters are adapted to detect static features in a large spatial range.

For example, in some embodiments, an integration time, a light emission intensity according to the integration time and a modulation frequency of the time-of-flight device is adapted (e.g., large integration time, low light emission intensity and small modulation frequency).

Moreover, in some embodiments, the control detects the region of interest based on the amplitude image by a simple edge detection or the like without requiring to construct a 3D point cloud (over a plurality of time points) based on the phase image to save computational resources.

Once a region of interest is detected, the control may adapt the radar device parameters such that the angular/distance resolution (and/or frame rate and/or field of view) is optimized for the detected region of interest.

It has been recognized that, for example in the object/passenger presence detection/registration mode, detection speed/accuracy may be enhanced, and power consumption may be reduced when, in the data processing of the radar data, the detected region of interest is used as prior knowledge, since a confidence level may already be sufficient when less time/spatial points are processed.

Hence, as mentioned above, in some embodiments, the circuitry is configured to extract, based on the radar data, information regarding passenger presence and/or behavior of the passenger in the cabin using the detected region of interest as prior knowledge.

The object/passenger tracking mode may be similar to the object/passenger presence detection/registration mode, however, the integration time, frame rate and modulation frequency of the time-of-flight device may be adapted to account, e.g., for fast scene changes in the cabin.

Moreover, for example, the data processing of the time-of-flight data may include the generation of a 3D point cloud based on the phase image to account, e.g., for 3D movements of objects/passengers.

In some embodiments, the control switches between the object/passenger presence detection/registration mode and the object/passenger tracking mode every predetermined time or based on a random number or the like.

It has further been recognized that, in addition to presence detection and tracking of objects/passengers, an analysis of the behavior of the objects/passengers is useful in some embodiments and that the operation mode should be adapted accordingly.

In particular, it has been recognized that certain parts of the passengers (e.g., head, chest, hands, fingers, etc.) should be detected and analyzed to get a meaning of their behavior. Hence, in some embodiments, in the object/passenger behavior recognition mode, the data processing and/or the data acquisition is adapted for optimized behavior recognition.

For example, the control may adapt the time-of-flight device parameters to detect smaller regions in the cabin more frequently and reliably by, e.g., adapting the frame rate, the modulation frequency and the field of illumination (e.g., increasing frame rate, increasing modulation frequency and decreasing field of illumination). Similar, for instance, the control adapts the radar device's field of view and distance/angular resolution towards smaller regions and higher resolution.

Moreover, in terms of data processing, it has been recognized that the information extracted based on the radar data should be used for detecting sub-regions of interest in the detected region of interest using the time-of-flight data, since, as mentioned above, the radar data provide extra information about visually occluded parts and tiny movements which may improve the analysis of the amplitude and phase image.

Hence, in some embodiments, the circuitry is configured to detect, based on the time-of-flight data, at least one sub-region of interest in the region of interest using the information extracted based on the radar data as prior knowledge.

The sub-regions of interest may be smaller regions in the region of interest, for example, the region of interest may be a passenger and the sub-regions of interest may be the head, chest, hands, fingers of the passenger.

As a next iteration step, in some embodiments, for further improving detection accuracy and, thus, enabling behavior recognition, both data are used in the sub-regions of interest to increase a confidence level.

Thus, in some embodiments, the circuitry is configured to extract, based on the time-of-flight data and the radar data, information regarding passenger presence and/or behavior of the passenger in the cabin in the sub-region of interest.

In some embodiments, for example, in the reduced power mode, the data processing is adapted to be performed less frequently than in a normal power mode and/or based only on a subset of data (e.g., only a spatial subset of data and/or a temporal subset of data). Moreover, in such embodiments, for instance, the data acquisition is adapted to acquire data less frequently than in a normal power mode and/or with lower light/radar wave emission intensity.

The control may determine to adapt the operation mode to the reduced power mode based on the vehicle state, e.g., when the vehicle is parking, and/or based on the region of interest, e.g., when no region of interest is detected or only luggage is detected to be present.

Hence, in some embodiments, the circuitry is configured to put the time-of-flight device and the radar device in a reduced power mode when a predetermined state of the vehicle is detected, and to detect, based on radar data acquired in the reduced power mode, passenger presence in the cabin.

In such embodiments, the time-of-flight device is put in a reduced power mode as well or is put in a sleep mode until the control instructs a wake-up of the time-of-flight device.

In some embodiments, the circuitry is configured to put, in response to the detection of passenger presence in the cabin, the time-of-flight device in a normal power mode for detecting a region of interest.

In some embodiments, the circuitry is configured to put, in response to the detection of the region of interest, the radar device in a normal power mode.

Accordingly, in some embodiments, the time-of-flight device is only waked-up when the radar data indicate passenger presence, since typically the radar device consumes less power than the time-of-flight device.

Moreover, the control instructs the radar device to operate only in normal power mode when the time-of-flight data indicate a region of interest for further inspection by the radar device.

Some embodiments pertain to a (corresponding) control method for an in-cabin monitoring system for a vehicle, wherein the in-cabin monitoring system includes the control, a time-of-flight device configured to perform a time-of-flight measurement to acquire time-of-flight data and a radar device configured to perform a radar measurement to acquire radar data, wherein the control method includes:
obtaining time-of-flight data and radar data;
performing, based on the time-of-flight data and the radar data, object/passenger monitoring in the cabin;
detecting, based on the time-of-flight data, a region of interest in the cabin; and
adapting, based on the detected region of interest, an operation mode of the in-cabin monitoring system.

The control method may be performed by the control as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

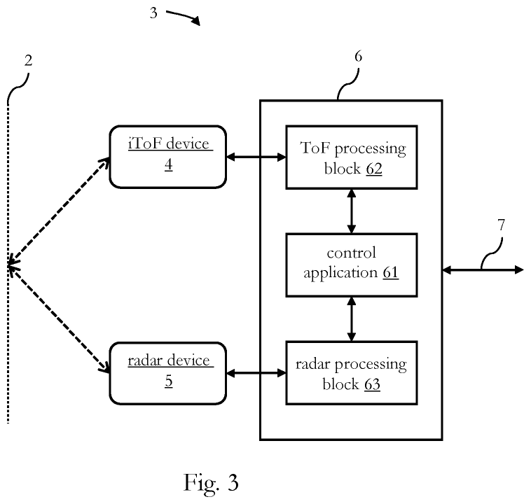

Returning to FIG. 1, there is schematically illustrated in a side view an embodiment of a vehicle 1 including an in-cabin monitoring system 3, which is discussed in the following under reference of FIGS. 1, 2 and 3, wherein FIG. 2 schematically illustrates in a bird's-eye view the embodiment of the vehicle 1 including the in-cabin monitoring system 3, and wherein FIG. 3 schematically illustrates in a block diagram an embodiment of the in-cabin monitoring system 3.

The vehicle 1 has a cabin 2, wherein the vehicle 1 is a car, in which the in-cabin monitoring system 3 is installed for monitoring objects/passengers in the cabin 2.

The in-cabin monitoring system 3 includes an indirect time-of-flight device 4 (iToF device in the following), a radar device 5 and a control 6.

The iToF device 4, the radar device 5 and the control 6 are connected to a CAN bus (not shown) to exchange data and commands via the CAN bus. The control 6 may further exchange data 7 with other sensors or actuators or control units of the vehicle 1. For example, the control 6 may receive vehicle state data indicating a state of the vehicle 1 (e.g., whether the vehicle 1 is moving or not, the engine is on, the doors are closed etc.) to detect whether the vehicle 1 is in a predetermined state.

The used positioning in the cabin 2 of the iTOF device 4 and the radar device 5 is shown in FIGS. 1 and 2, where the iToF device 4 is installed on the middle top-roof position (to have least amount of visual occlusions for the seats and the footwell) and the radar device 5 is installed in area around the rear-mirror of the vehicle 1 and oriented towards the passengers to have best distinction in a radial-distance direction.

The positioning of both the radar device 5 and the iToF device 4 may also take other absolute and relative positions in other embodiments, depending on the type of the vehicle 1 and application scenarios. However, the main constraints are sufficient overlapping area of the field of view, as illustrated by the dashed and dotted lines in FIGS. 1 and 2, for precise calibration in both off-line and on-line mode, and largest possible non-overlapping 3D area which can be used to complement one sensing system by the other. Additionally, in other embodiments, exploiting the best position by both sensors, independently in a specific vehicle, is proposed to define the position of sensors.

In some embodiments, the iToF device 4 and the radar device 5 are coupled to an actuator to adapt the emission/detection direction, for example, based on a detected region of interest. The iToF device 4 may include one image sensor and one light source to generate the field of view (dashed line in FIGS. 1 and 2) or the iToF device 4 may include, for example, two image sensors and two light sources to monitor opposite directions. Hence, the iToF device 4 may include two independent sub-devices for improving detection range and accuracy, wherein the respective data are fused to generate combined image/depth information.

The radar device 5 may include one or more antenna arrays each including a plurality of antennas for transmitting and receiving radar signals.

Some targets of the in-cabin monitoring system 3 utilizing radar-iToF fusion include in some embodiments:

Monitoring specific places: front seats, rear seats and footwell.

Detecting the number of occupants in the vehicle 1 when the car is static or moving.

Detecting whether a child is left alone in the car when the car is static, the child is sleeping or awake, and the child is covered or not (visually occluded).

Detecting the behavior of passengers (for example: the car is driven and in the back the children are doing something that might not be safe), wherein detecting the behavior includes: using the ToF data to detect parts of the body such as head/face/chest (and e.g. whether eyes are open), using the radar data for detecting whether a passenger (e.g., a child) is sleeping or not (e.g., the passenger is not moving and with breathing indicates that the passenger is sleeping), and refining smaller sub-regions of interest in a larger region of interest for radar inspection regarding the breathing and for using the 2D confidence image (amplitude image) for visible facial features.

Adapting to movable seats and seating poses in future in-cabin autonomous systems.

Referring to FIG. 3, the control 6 includes a processor which executes a control application 61 for controlling the overall operation of the in-cabin monitoring system 3, a ToF processing block 62 to process the ToF data obtained from the iToF device 4 and a radar processing block 63 for processing the radar data obtained from the radar device 5.

Generally, the control 6 obtains time-of-flight data (ToF data in the following) from the iToF device 4 and radar data from the radar device 5 via the CAN bus for sensor fusion for performing, based on the ToF data and the radar data, object/passenger monitoring in the cabin 2.

Performing object/passenger monitoring includes detecting a presence of an object/passenger in the cabin, registration of the detected object/passenger, tracking of the detected object/passenger in the cabin and recognition of a behavior of the detected object/passenger. In some embodiments, performing object/passenger monitoring includes detecting occlusions of objects/passengers.

Typically, the ToF data is processed in the ToF processing block 62, and the radar data is processed in the radar processing block 63, wherein the control application 61 supplies information extracted based on the ToF data (processed ToF data) to the radar processing block 63 as prior knowledge, and supplies information extracted based on the radar data (processed radar data) to the ToF processing block 62 as prior knowledge. However, the control application 61 may also use the ToF data and the radar data for processing based on both data sets.

Generally, the control 6 detects, based on the ToF data, a region of interest in the cabin 2, and adapts, based on the region of interest, an operation mode of the in-cabin monitoring system 3. Adapting an operation mode includes adapting a data processing mode of the control 6 and/or adapting a data acquisition mode of iToF device 4 and/or the radar device 5.

Adapting a data acquisition mode of the radar device 5 includes adapting device parameters including at least one of a frame rate, a field of view, an angular/distance/velocity resolution and a power mode.

Adapting a data acquisition mode of the iToF device 4 includes adapting device parameters including at least one of an integration time, a frame rate, a modulation frequency, a field of illumination, multi-wavelength light emission and a power mode.

Moreover, in some embodiments, the control 6 adapts the data processing mode in the radar processing block 63 to process only radar data corresponding to a field of interest in the field of view of the radar device. For example, the number of angles in the radar data which is processed is limited. A certain range of angles may be kept (e.g., −45° to +45° in 15° steps) which is processed while the other information (<−45° and)>+45° is dropped. Hence, in some embodiments, a field of interest is adapted during the processing stage.

In FIG. 3, a general overview of the interactive framework is depicted including the communication on the sensor system level (4, 5) and on the processing block level (62, 63). Moreover, as mentioned above, the control application 61 is shown, which collects the processed data and uses the extracted information to tune on both the sensor system level and the processing block level.

In such manner, the control 6 influences both the sensing and the way the sensed data is processed based on the extracted prior knowledge of the same and other sensor-processed data, as may be referred to as auto bi-directional inter and intra calibration.

Generally, as discussed above, bi-directional adaptations of both sensing pipelines for the in-cabin monitoring system are employed. For the sensor fusion, the ToF data is used for rough 3D localization and recognition of the 3D regions of interest, related to volumes of occupants, child seat, children, animals and other objects of interest. Once a rough position is detected and initial estimate of the occupant position is known, the radar sensing is used for more detailed occupant inspection and monitoring in terms of tiny/fine movements and breathing for example.

Hence, the control 6 extracts, based on the radar data, information regarding passenger presence and/or behavior of the passenger in the cabin using the detected region of interest as prior knowledge.

This may be important for cases when occupants are not moving at all, for example sleeping, in which case it may be difficult for only the radar-system to distinguish between the background (seat) and the occupant. Using the ToF data may help to avoid occupant detection and localization miss, i.e., false negative. Apart from the point cloud data (based on phase image), also ToF confidence data (amplitude image) may be used to detect, e.g., the head region of interest, in case it is not visually occluded.

In terms of the radar device parameter tuning on the sensor system level, as discussed above, the control 6 adapts, for example, the power mode and the field of view depending on the input from the TOF processing block 62 to focus more on selected 3D regions of interest and hence increase the distance and angular resolution of the radar data acquired. In other cases, when there is not much activity, the control 6, for instance, reduces the power of the radar device 5 and instructs to enlarge the field of view to follow up on the more global changes.

Typically, the use of radar signals may avoid issues with occlusions of the objects/passengers, since detection problems due to different materials of the objects/passengers in the car are reduced, as may be the case with the iToF device 4.

Hence, there may be an additional benefit of fusing the radar data and the ToF data on the same region of interest, for example, in cases when an object/passenger is partially visually occluded or invisible by the IR technology of the iToF device 4 due to the material of the object. In such cases, combining radar and ToF information may facilitate occupant recognition and tracking their activity, compared to the case when only ToF technology is used.

Moreover, it has been recognized that using the ToF information to complement on radar motion sensing for a particular occupant or more than one occupant and their interactive behavior may improve behavior recognition of the passengers in the vehicle 1, since the radar device 5 typically provides only approximate information regarding the position of the occupant in question.

The ToF data is thus used in combination with the radar data to detect, e.g., body/arms/head of the occupants to understand movements of these parts and hence conclude about their behavior. This may allow full and extended in-cabin safety monitoring with multiple objects and tasks, such as detecting and registering presence of passengers in the vehicle 1 and also their activity, precise positions as well as interactions with other passengers and objects in the car.

Hence, the control 6 detects, based on the ToF data, at least one sub-region of interest in the region of interest using the information extracted based on the radar data as prior knowledge.

Moreover, the control 6 extracts, based on the time-of-flight data and the radar data, information regarding passenger presence and/or behavior of the passenger in the cabin in the sub-region of interest.

In terms of the iToF device parameters tuning on the sensor system level, as discussed above, the radar processing block 63 provides information to tune the ToF data acquisition on the system level using the device parameters: integration time, frame rate, modulation frequency, field of illumination, multi-wavelength light emitter adaptation and power mode. The control 6 uses the output from the iToF device 4 to confirm human, animal or child seat presence and confirm results obtained based on the radar data.

Some envisaged use-case scenarios include in some embodiments:

In stationary conditions (e.g., not much in-cabin activity), the radar device 5 is working in a reduced power mode monitoring for any possible changes occurring (because, typically, the radar device 5 consumes less power than the iToF device). In such scenario, the iToF device may work in a reduced power mode with reduced frame rate (e.g., 2-3 fps) and reduced emitter light strength. When the radar device 5 starts noticing some changes, the iToF device 4 starts working in a normal power mode with higher fps and using higher level of emitter light strength for detecting a 3D region of interest. Then, the control 6 optimizes the radar device 5 parameters (e.g., narrowing down the field of view and increasing the angular resolution) to detect more tiny movements and other important details.

Once the fused radar and ToF processing blocks 63 and 62 indicate more precisely the region of interest for inspection and possibly even parts of the occupant body, the control 6 adapts the ToF device 4 parameters, e.g., the modulation frequency to reduce the distance range with increasing the precision of the depth information, hence going into the finer details about object structure and movements, enabling hence more accurate activity behavior recognition.

Adapting a field of illumination of the iToF device 4 based on feedback from the radar device 5 to manage power.

Adapting an integration time of the iToF device 4, e.g., depending upon scene distance and/or reflectivity.

Increasing the frame rate of the iToF device 4 when information about sub-regions of interest is known, such that, for example, only that part of the data is extracted and further processed to be finally used with the radar data in the loop.

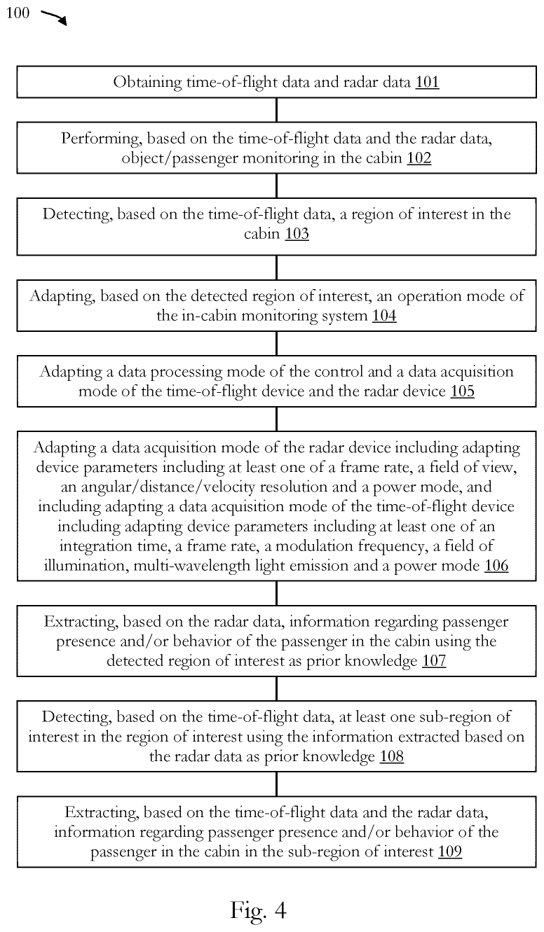

FIG. 4 schematically illustrates in a flow diagram an embodiment of a control method 100 for an in-cabin monitoring system for a vehicle, which is discussed in the following.

The control method 100 is performed by the control 6 of the in-cabin monitoring system 3 of the vehicle 1, as discussed under reference of FIGS. 1, 2 and 3.

At 101, time-of-flight data and radar data is obtained, as discussed herein.

At 102, based on the time-of-flight data and the radar data, object/passenger monitoring in the cabin is performed, as discussed herein.

At 103, based on the time-of-flight data, a region of interest in the cabin is detected, as discussed herein.

At 104, based on the detected region of interest, an operation mode of the in-cabin monitoring system is adapted, as discussed herein.

At 105, a data processing mode of the control and a data acquisition mode of the time-of-flight device and the radar device is adapted, as discussed herein.

At 106, adapting a data acquisition mode of the radar device includes adapting device parameters including at least one of a frame rate, a field of view, an angular/distance/velocity resolution and a power mode, and includes adapting a data acquisition mode of the time-of-flight device including adapting device parameters including at least one of an integration time, a frame rate, a modulation frequency, a field of illumination, multi-wavelength light emission and a power mode, as discussed herein.

At 107, based on the radar data, information regarding passenger presence and/or behavior of the passenger in the cabin is extracted using the detected region of interest as prior knowledge, as discussed herein.

At 108, based on the time-of-flight data, at least one sub-region of interest in the region of interest is detected using the information extracted based on the radar data as prior knowledge, as discussed herein.

At 109, based on the time-of-flight data and the radar data, information regarding passenger presence and/or behavior of the passenger in the cabin in the sub-region of interest is extracted, as discussed herein.

Returning to the general explanations, summarizing some aspects of some embodiments of an in-cabin monitoring system as described herein:

It is envisaged to monitor the full in-cabin, including the back seat activity and its correlation with the front seat occupant presence and activity. The use of 3D point cloud data obtained from the iToF device is considered in combination with the radar device, for example, attached next to it or both split up in location of the car. Either mounted close or further away, in some embodiments, the two devices are precisely calibrated and complementary to make use of both detection technologies and redundancy for eventual functional safety compliancy. Based on the sensors' position and the acquired and fused data, in some embodiments, the occupants are registered, and their pose is estimated, describing the activity (e.g. driver body turned to back, head turned back, driver out of seat position, child lying—not moving (breathing), child moving, child seating, etc.). By fusing the information of iToF device and the radar device, in some embodiments, the whole in-cabin in a multi-scale sense is covered: from a rough scale counting the number of occupants (including children and animals), their 3D position and activity to more precise recognition tasks in regard to each occupant, such as body shape, size, age, gender and other relevant information for safety issues in the vehicle. In some embodiments, the position of the iToF device is in the middle roof area (see, e.g., FIGS. 1 and 2) to have minimum amount of visual occlusions, while the radar device should optimally be put in area around the mirror window to facilitate maximum distinction in radial-distance direction.

In some embodiments, using ToF data to perform 3D monitoring and recognition of the 3D volume around specific objects of interest, in the cabin of the vehicle, such as a child seat or any other important object in the car needed for more precise movements inside this 3D box by the radar device.

For example, a specific case of interest is detecting a child seat with the use of the iTOF device to detect 3D bounding box of the child seat (with or without child) and then use the radar device to focus only on this 3D area to be more sensitive and less prone to noise.

Within the bounding box, in some embodiments, the control detects the movements and respiration under the occlusion by radar data fusion for improved 3D registration of the occupant body poses, shapes and motion tracking.

Application scenarios includes for example: pre-crash protection with intervention and safety warnings and/or post-crash detection of posture/severity of injury and health monitoring.

In some embodiments, using the iToF device to reduce noise and precision in radar imaging by using prior knowledge obtained based on the ToF data.

Fusing iToF device and radar device, in some embodiments, for monitoring footwell area in the vehicle 1 and detecting and recognizing the objects and their movements.

Fusing iToF device and radar device, in some embodiments, for monitoring driver behavior in regard to driver distraction (e.g., turning back to the rear seat, leaning the body to footwell area) and sudden sickness (tiny movements of the head and respiration of the driver, as well as other medical issues that can impact the safety in driving).

Using the iToF device in combination with the radar device, in some embodiments, to detect head and chest of the occupants and use facial features (from iToF confidence data) to conclude about sleeping or not by narrowing down the region of interest for breathing detection via radar device.

Complementing the radar-based sensing with iToF-based sensing, in some embodiments, regarding detection of body/arms/head of the occupants to understand movements of these parts and hence conclude about occupant behavior/activity.

Complementing, in some embodiments, iToF-based sensing in case of visual occlusions and problems with material due to use of IR technology by using the radar device to see through the objects and also to use semi-reflectivity to extract the missing reflections.

In some embodiments, reducing complexity of radar detection as via predefined scheme, the radar device can adapt on the detect context. For example: via iToF face/chest detection and then detailed scan for human vital signs monitoring via radar device and/or child seat detection via iToF and additional detailed scanning for breathing child only in certain area, and not the whole in cabin.

In some embodiments, use the iTOF device for more precise and robust recognition of the 3D objects and corresponding 3D regions of interest, e.g., bounding boxes in the cabin of the vehicle, such as child seat or any other important object/occupant in the car needed to detect more accurate movements inside this 3D box. Then, in some embodiments, use the radar device for more precise detection of living objects under the occlusion/cover, such as blankets.

In some embodiments, focusing only on this 3D area to be more sensitive to detect the heartbeat or breathing.

In some embodiments, using the iToF device in combination with the radar device to:

Detect head and chest of the occupants and use facial features to conclude about sleeping or not (narrow down the region of interest for breathing detection).

Using the fact that the radar device is typically to certain extent transparent while also leaving some reflectivity which is scattered more or less, depending on the material. Hence, exploiting the properties of material dependence of the iToF device and the radar device for complementing weakness in some cases.

In some cases, for certain materials, the iToF device 4 may have limited performance: hair, special clothing, etc. and where some gaps exist in the depth and reflection data. For such reason, the 3D recognition task might reduce its performance and may fail. Fusing the ToF data with radar data may also facilitate reconstruction of the missing parts due to reduced iToF signal level and/or object occlusion. The ToF data may be used to obtain a rough estimated of the 3D object surface and volume, while the radar data may allow to add the missing parts of the 3D object through the fusion process to improve the recognition performance.

In some embodiments, extracting accurate 3D body and body characteristics/head registration/pose estimation/tracking in real-time of adult occupants and children. In some embodiments, occupant activity recognition including: monitoring the child movement in the vehicle and interaction with other passengers as well as behavior monitoring of the driver, related to driving or non-driving task that can impact child and other occupant safety. For example, phone usage while driving can be monitored or turning around to see what the other occupants are doing in the vehicle in the back.

In some embodiments, monitoring of footwell of the car, in both front and rear, may be a scenario where iTOF-radar fusion may be beneficial for detecting and recognizing the objects, size and their movements.

In some embodiments, inter sensor system adaptation based on other sensor processing block output:

Using the ToF processing block output to tune the radar sensor settings in real-time: frame rate, field of view, angular/distance/velocity resolution and power mode.

Using the radar processing block output to tune the TOF sensor settings in real-time: power level, fps, modulation frequency, integration time, field of illumination, wavelength and the bandwidth of the wavelengths of the emitting active light source.

The setup may reduce power consumption and processing power of the in-cabin monitoring system inside the car.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A control for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, wherein the control includes circuitry configured to:
obtain time-of-flight data and radar data;
perform, based on the time-of-flight data and the radar data, object/passenger monitoring in the cabin;
detect, based on the time-of-flight data, a region of interest in the cabin; and
adapt, based on the detected region of interest, an operation mode of the in-cabin monitoring system.
(2) The control of (1), wherein adapting an operation mode includes adapting a data processing mode of the control and/or adapting a data acquisition mode of the time-of-flight device and/or the radar device.
(3) The control of (2), wherein the circuitry is configured to extract, based on the radar data, information regarding passenger presence and/or behavior of the passenger in the cabin using the detected region of interest as prior knowledge.
(4) The control of (3), wherein the circuitry is configured to detect, based on the time-of-flight data, at least one sub-region of interest in the region of interest using the information extracted based on the radar data as prior knowledge.
(5) The control of (4), wherein the circuitry is configured to extract, based on the time-of-flight data and the radar data, information regarding passenger presence and/or behavior of the passenger in the cabin in the sub-region of interest.
(6) The control of anyone of (2) to (5), wherein adapting a data acquisition mode of the radar device includes adapting device parameters including at least one of a frame rate, a field of view, an angular/distance/velocity resolution and a power mode.
(7) The control of anyone of (2) to (6), wherein adapting a data acquisition mode of the time-of-flight device includes adapting device parameters including at least one of an integration time, a frame rate, a modulation frequency, a field of illumination, multi-wavelength light emission and a power mode.
(8) The control of anyone of (1) to (7), wherein the circuitry is configured to:
put the radar device in a reduced power mode when a predetermined state of the vehicle is detected; and
detect, based on radar data acquired in the reduced power mode, passenger presence in the cabin.
(9) The control of (8), wherein the circuitry is configured to put, in response to the detection of passenger presence in the cabin, the time-of-flight device in a normal power mode for detecting a region of interest.
(10) The control of (9), wherein the circuitry is configured to put, in response to the detection of the region of interest, the radar device in a normal power mode.
(11) The control of anyone of (1) to (10), wherein performing object/passenger monitoring includes detecting a presence of an object/passenger in the cabin, registration of the detected object/passenger, tracking of the detected object/passenger in the cabin and recognition of a behavior of the detected object/passenger.
(12) A control method for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, wherein the control method includes:
obtaining time-of-flight data and radar data;
performing, based on the time-of-flight data and the radar data, object/passenger monitoring in the cabin;
detecting, based on the time-of-flight data, a region of interest in the cabin; and
adapting, based on the detected region of interest, an operation mode of the in-cabin monitoring system.
(13) The control method of (12), wherein adapting an operation mode includes adapting a data processing mode of the control and/or adapting a data acquisition mode of the time-of-flight device and/or the radar device.
(14) The control method of (13), including: extracting, based on the radar data, information regarding passenger presence and/or behavior of the passenger in the cabin using the detected region of interest as prior knowledge.
(15) The control method of (14), including: detecting, based on the time-of-flight data, at least one sub-region of interest in the region of interest using the information extracted based on the radar data as prior knowledge.
(16) The control method of (15), including: extracting, based on the time-of-flight data and the radar data, information regarding passenger presence and/or behavior of the passenger in the cabin in the sub-region of interest.
(17) The control method of anyone of (13) to (16), wherein adapting a data acquisition mode of the radar device includes adapting device parameters including at least one of a frame rate, a field of view, an angular/distance/velocity resolution and a power mode, and/or wherein adapting a data acquisition mode of the time-of-flight device includes adapting device parameters including at least one of an integration time, a frame rate, a modulation frequency, a field of illumination, multi-wavelength light emission and a power mode.
(18) An in-cabin monitoring system for a vehicle, wherein the in-cabin monitoring system includes:
a time-of-flight device configured to perform a time-of-flight measurement to acquire time-of-flight data;
a radar device configured to perform a radar measurement to acquire radar data; and
a control, including circuitry configured to:
   obtain time-of-flight data and radar data,
   perform, based on the time-of-flight data and the radar data, object/passenger monitoring in the cabin,
   detect, based on the time-of-flight data, a region of interest in the cabin, and
   adapt, based on the detected region of interest, an operation mode of the in-cabin monitoring system.
(19) A vehicle, wherein the vehicle includes an in-cabin monitoring system including:
a time-of-flight device configured to perform a time-of-flight measurement to acquire time-of-flight data;
a radar device configured to perform a radar measurement to acquire radar data; and
a control, including circuitry configured to:
   obtain time-of-flight data and radar data,
   perform, based on the time-of-flight data and the radar data, object/passenger monitoring in the cabin,
   detect, based on the time-of-flight data, a region of interest in the cabin, and
   adapt, based on the detected region of interest, an operation mode of the in-cabin monitoring system.
(20) The vehicle of (19), wherein the vehicle is a car, and wherein the time-of-flight device is installed at a middle top-roof position and the radar device is installed at the rear-mirror position.
(21) A computer program comprising program code causing a computer to perform the method according to anyone of (12) to (17), when being carried out on a computer.
(22) A non-transitory computer-readable recording medium that stores therein a computer program product, which, when executed by a processor, causes the method according to anyone of (12) to (17) to be performed.

1. A control for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, comprising circuitry configured to:
obtain time-of-flight data and radar data;
perform, based on the time-of-flight data and the radar data, object/passenger monitoring in the cabin;
detect, based on the time-of-flight data, a region of interest in the cabin; and
adapt, based on the detected region of interest, an operation mode of the in-cabin monitoring system.

2. The control according to claim 1, wherein adapting an operation mode includes adapting a data processing mode of the control and/or adapting a data acquisition mode of the time-of-flight device and/or the radar device.

3. The control according to claim 2, wherein the circuitry is configured to extract, based on the radar data, information regarding passenger presence and/or behavior of the passenger in the cabin using the detected region of interest as prior knowledge.

4. The control according to claim 3, wherein the circuitry is configured to detect, based on the time-of-flight data, at least one sub-region of interest in the region of interest using the information extracted based on the radar data as prior knowledge.

5. The control according to claim 4, wherein the circuitry is configured to extract, based on the time-of-flight data and the radar data, information regarding passenger presence and/or behavior of the passenger in the cabin in the sub-region of interest.

6. The control according to claim 2, wherein adapting a data acquisition mode of the radar device includes adapting device parameters including at least one of a frame rate, a field of view, an angular/distance/velocity resolution and a power mode.

7. The control according to claim 2, wherein adapting a data acquisition mode of the time-of-flight device includes adapting device parameters including at least one of an integration time, a frame rate, a modulation frequency, a field of illumination, multi-wavelength light emission and a power mode.

8. The control according to claim 1, wherein the circuitry is configured to:
put the radar device in a reduced power mode when a predetermined state of the vehicle is detected; and
detect, based on radar data acquired in the reduced power mode, passenger presence in the cabin.

9. The control according to claim 8, wherein the circuitry is configured to put, in response to the detection of passenger presence in the cabin, the time-of-flight device in a normal power mode for detecting a region of interest.

10. The control according to claim 9, wherein the circuitry is configured to put, in response to the detection of the region of interest, the radar device in a normal power mode.

11. The control according to claim 1, wherein performing object/passenger monitoring includes detecting a presence of an object/passenger in the cabin, registration of the detected object/passenger, tracking of the detected object/passenger in the cabin and recognition of a behavior of the detected object/passenger.

12. A control method for an in-cabin monitoring system for a vehicle, the in-cabin monitoring system including the control, a time-of-flight device configured to perform a time-of-flight measurement to acquire time-of-flight data and a radar device configured to perform a radar measurement to acquire radar data, comprising:
obtaining time-of-flight data and radar data;
performing, based on the time-of-flight data and the radar data, object/passenger monitoring in the cabin;
detecting, based on the time-of-flight data, a region of interest in the cabin; and
adapting, based on the detected region of interest, an operation mode of the in-cabin monitoring system.

13. The control method according to claim 12, wherein adapting an operation mode includes adapting a data processing mode of the control and/or adapting a data acquisition mode of the time-of-flight device and/or the radar device.

14. The control method according to claim 13, comprising: extracting, based on the radar data, information regarding passenger presence and/or behavior of the passenger in the cabin using the detected region of interest as prior knowledge.

15. The control method according to claim 14, comprising: detecting, based on the time-of-flight data, at least one sub-region of interest in the region of interest using the information extracted based on the radar data as prior knowledge.

16. The control method according to claim 15, comprising: extracting, based on the time-of-flight data and the radar data, information regarding passenger presence and/or behavior of the passenger in the cabin in the sub-region of interest.

17. The control method according to claim 13, wherein adapting a data acquisition mode of the radar device includes adapting device parameters including at least one of a frame rate, a field of view, an angular/distance/velocity resolution and a power mode, and/or wherein adapting a data acquisition mode of the time-of-flight device includes adapting device parameters including at least one of an integration time, a frame rate, a modulation frequency, a field of illumination, multi-wavelength light emission and a power mode.

18. An in-cabin monitoring system for a vehicle, comprising:
a time-of-flight device configured to perform a time-of-flight measurement to acquire time-of-flight data;
a radar device configured to perform a radar measurement to acquire radar data; and
a control, including circuitry configured to:
obtain time-of-flight data and radar data,
perform, based on the time-of-flight data and the radar data, object/passenger monitoring in the cabin,
detect, based on the time-of-flight data, a region of interest in the cabin, and
adapt, based on the detected region of interest, an operation mode of the in-cabin monitoring system.

19. A vehicle, comprising an in-cabin monitoring system including:
a time-of-flight device configured to perform a time-of-flight measurement to acquire time-of-flight data;
a radar device configured to perform a radar measurement to acquire radar data; and
a control, including circuitry configured to:
obtain time-of-flight data and radar data,
perform, based on the time-of-flight data and the radar data, object/passenger monitoring in the cabin,
detect, based on the time-of-flight data, a region of interest in the cabin, and
adapt, based on the detected region of interest, an operation mode of the in-cabin monitoring system.

20. The vehicle according to claim 19, wherein the vehicle is a car, and wherein the time-of-flight device is installed at a middle top-roof position and the radar device is installed at the rear-mirror position.
